(19) United States
(12) Patent Application Publication
(10) Pub. No.: US 2024/0265758 A1
(43) Pub. Date: Aug. 8, 2024

(54) AUTHENTICATION DEVICE, AUTHENTICATION METHOD, AUTHENTICATION SYSTEM, AND PROGRAM

(71) Applicant: Panasonic Intellectual Property Management Co., Ltd., Osaka (JP)

(72) Inventors: Masao KUBOTA, Tokyo (JP); Yoshinori KUNIEDA, Tokyo (JP)

(73) Assignee: Panasonic Intellectual Property Management Co., Ltd., Osaka (JP)

(21) Appl. No.: 18/563,206

(22) PCT Filed: Feb. 28, 2022
(86) PCT No.: PCT/JP2022/008343

§ 371 Date: Nov. 21, 2023

(30) Foreign Application Priority Data
May 25, 2021 (JP) 2021-087546

(51) Int. Cl. G07C 9/25

(52) U.S. Cl. CPC G07C 9/25

(57) ABSTRACT

An authentication apparatus comprises: a processor that performs processing of associating registration information of an incoming person with one registered face image of a plurality of registered face images; and an authenticator that prioritizes a collation result between the registered face image associated with the registration information and the face image information of the incoming person over a collation result between a registered face image not associated with the registration information and the face image information of the incoming person.

### TECHNICAL FIELD

The present disclosure relates to an authentication apparatus, an authentication method, an authentication system, and a program.

### BACKGROUND ART

There is known a technique of using face authentication to manage entry and exit of a person passing through a gate apparatus installed at a train station, an airport, or the like. For example, Patent Literature (hereinafter referred to as “PTL”) 1 discloses a gate apparatus capable of performing face authentication of a person who comes into the gate apparatus (hereinafter, such a person may be referred to as “incoming person”) based on a facial feature value registered in association with an identifier transmitted by a wireless tag possessed by the incoming person.

### CITATION LIST

### Patent Literature

### PTL 1

Japanese Patent No. 6816821

### SUMMARY OF INVENTION

### Technical Problem

Incidentally, in a case where an authentication system including a gate apparatus that supports face authentication in the future is deployed at a train station or the like having a large number of users, the number of registered persons in the authentication system may be enormous. When the number of registered persons increases, the number of registered persons who have similar facial features also increases, and thus, there may be erroneous authentication occurring in face authentication of an incoming person who comes into the gate apparatus.

A gate apparatus that supports face authentication has the advantage of an incoming person being able to pass through the gate apparatus without using a special apparatus for authentication processing. In a case where authentication is performed only based on facial features, however, there is a certain limit to authentication accuracy as described above. It is therefore required to devise further enhanced authentication accuracy while enjoying the advantage.

An object of the present disclosure is to provide an authentication apparatus, an authentication method, an authentication system, and a program each capable of enhancing authentication accuracy while enjoying an advantage of a gate apparatus that supports face authentication.

### Solution to Problem

An authentication apparatus according to the present disclosure includes: a processor that performs processing of associating, in a case where a portable terminal of an incoming person who comes into a gate apparatus is present near the gate apparatus, registration information, which is information of the incoming person who comes into the gate apparatus and which is registered in the portable terminal, with one registered face image of a plurality of registered face images; and an authenticator that prioritizes, in authentication processing of authenticating the incoming person based on collation results between face image information of the incoming person and the plurality of registered face images, a collation result between the registered face image associated with the registration information and the face image information of the incoming person over a collation result between a registered face image not associated with the registration information and the face image information of the incoming person.

An authentication method according to the present disclosure includes: performing processing of associating, in a case where a portable terminal of an incoming person who comes into a gate apparatus is present near the gate apparatus, registration information, which is information of the incoming person who comes into the gate apparatus and which is registered in the portable terminal, with one registered face image of a plurality of registered face images; and prioritizing, in authentication processing of authenticating the incoming person based on collation results between face image information of the incoming person and the plurality of registered face images, a collation result between the registered face image associated with the registration information and the face image information of the incoming person over a collation result between a registered face image not associated with the registration information and the face image information of the incoming person.

An authentication system according to the present disclosure includes: a gate apparatus that allows an incoming person to come into the gate apparatus: an image-capturing apparatus that is provided corresponding to the gate apparatus and captures face image information of the incoming person: a beacon apparatus that is provided corresponding to the gate apparatus and transmits beacon information to a portable terminal possessed by the incoming person; and an authentication apparatus that associates registration information, which is information of the incoming person who comes into the gate apparatus and which is registered in the portable terminal, with one registered face image of a plurality of registered face images in response to reception of the beacon information by the portable terminal, and prioritizes, in authentication processing of authenticating the incoming person based on collation results between the face image information and the plurality of registered face images, a collation result between the registered face image associated with the registration information and the face image information of the incoming person over a collation result between a registered face image not associated with the registration information and the face image information of the incoming person.

A program according to the present disclosure is a program to be executed by a computer of a portable terminal, which is used together with an authentication apparatus, to control the portable terminal. The authentication apparatus performs actions including: performing processing of associating registration information with one registered face image of a plurality of registered face images, the registration information being transmitted from the portable terminal and indicating a user of the portable terminal; and prioritizing, in authentication processing of authenticating an incoming person who comes into a gate apparatus based on collation results between face image information of the incoming person and the plurality of registered face images, a collation result between the registered face image associated with the registration information and the face image information of the incoming person over a collation result between a registered face image not associated with the registration information and the face image information of the incoming person. The program causes, in a case where beacon information is received, the computer of the portable terminal to execute processing of controlling such that the beacon information and the registration information are transmitted.

### Advantageous Effects of Invention

According to the present disclosure, it is possible to enhance authentication accuracy while enjoying an advantage of a gate apparatus that supports face authentication.

### BRIEF DESCRIPTION OF DRAWINGS

FIG. 1 illustrates a configuration example of an authentication system according to the present disclosure;

FIG. 2 illustrates an example of association of a registered face image with beacon catch information in a user management server:

FIG. 3 illustrates processed scores of a plurality of authentication candidates:

FIG. 4 is a flowchart illustrating an operation example of authentication control in an authentication apparatus:

FIG. 5 is a flowchart illustrating an operation example of registration control of beacon catch information in the authentication apparatus:

FIG. 6 is a flowchart illustrating an operation example of transmission control of beacon catch information in a portable terminal;

FIG. 7 illustrates processed scores of a plurality of authentication candidates in the authentication apparatus according to a variation:

FIG. 8 is a flowchart illustrating an operation example of authentication control in the authentication apparatus according to a variation:

FIG. 9 illustrates a beacon apparatus arrangement relationship in a configuration including a plurality of beacon apparatuses; and

FIG. 10 illustrates a beacon apparatus arrangement relationship in a configuration including a plurality of beacon apparatuses.

### DESCRIPTION OF EMBODIMENTS

### Embodiment

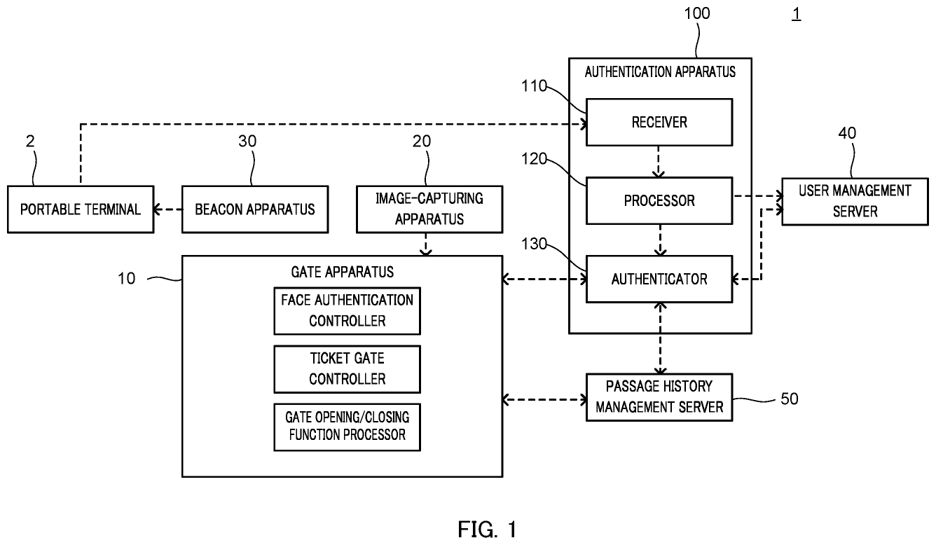

Hereinafter, an embodiment of the present disclosure will be described in detail with reference to the accompanying drawings. FIG. 1 illustrates a configuration example of an authentication system according to the present disclosure.

As illustrated in FIG. 1, authentication system 1 according to the present embodiment is, for example, a system that controls a gate apparatus (an entrance gate, a ticket gate, or the like) installed at an entrance and exit of a facility such as an airport, a train station, and an event venue.

In authentication system 1 according to the present embodiment, management of entry and exit of a user who uses a facility is executed by face authentication. For example, in a case where an incoming person who comes into a gate apparatus enters a facility through the gate apparatus, it is determined by face authentication whether the incoming person is a person authorized to enter the facility. Further, in a case where an incoming person exits a facility through a gate apparatus, it is determined by face authentication whether the incoming person is a person authorized to exit the facility. Note that, the “face authentication” may be regarded as a concept included in “collation using a face image”.

Authentication system 1 includes gate apparatus 10, image-capturing apparatus 20, beacon apparatus 30, user management server 40, passage history management server 50, and authentication apparatus 100.

Gate apparatus 10 is, for example, an automatic ticket gate installed at a facility such as a train station, and is configured to enable an incoming person to come into gate apparatus 10. Gate apparatus 10 includes a central processing unit (CPU) (not illustrated), a read only memory (ROM) (not illustrated), a random access memory (RAM) (not illustrated), and input/output circuitry (not illustrated).

Gate apparatus 10 includes a face authentication controller, a ticket gate controller, and a gate opening/closing function processor, and the like, and performs control such that a person authorized to enter and exit a facility is allowed to come into gate apparatus 10 and a person unauthorized to enter and exit the facility is prevented from coming into gate apparatus 10.

Image-capturing apparatus 20 is a camera that captures a face image of an incoming person who comes into gate apparatus 10, and is provided corresponding to gate apparatus 10. In gate apparatus 10, the face authentication controller transmits information on a face image captured by image-capturing apparatus 20 to authentication apparatus 100 and requests collation of the face image of the incoming person. Then, the face authentication controller acquires a collation result of the face image from authentication apparatus 100, and the ticket gate controller controls the gate opening/closing function processor based on the collation result, and thus, the opening/closing of the gate is controlled.

Beacon apparatus 30 is an apparatus that transmits beacon information, and is provided corresponding to gate apparatus 10. Beacon information is a signal that makes it possible to detect, by a reception apparatus receiving the beacon information (receiving a wave), an identification number or the like that is given to beacon apparatus 30 that has transmitted the beacon information. Beacon information transmitted by beacon apparatus 30 is received by portable terminal 2 possessed by an incoming person who comes into gate apparatus 10. Note that, it is assumed in the present embodiment that beacon apparatus 30 transmits beacon information by using Bluetooth (registered trademark). Beacon apparatus 30, however, may transmit beacon information by another radio communication method. Further, when a reception apparatus is constantly exposed, beacon apparatus 30 may transmit beacon information not by a radio wave, but by light such as infrared light.

Further, beacon apparatus 30 may also be operated by the power supply of gate apparatus 10. In this way, it is not necessary to take a limited driving time into consideration as in a battery-driven beacon apparatus, and thus, it is possible to freely configure the transmission cycle or the like of beacon information.

Portable terminal 2 is, for example, a portable terminal such as a smartphone possessed by an incoming person, and includes a CPU (not illustrated), a ROM (not illustrated), a RAM (not illustrated), and input/output circuitry (not illustrated). A dedicated application that supports authentication system 1 is installed into portable terminal 2, and portable terminal 2 is configured to be capable of receiving beacon information transmitted by beacon apparatus 30. When portable terminal 2 receives beacon information, beacon catch information is transmitted to authentication apparatus 100.

Beacon catch information is information that indicates that portable terminal 2 has received beacon information, and includes a reception time of the beacon information at portable terminal 2, registration information of an incoming person, beacon information of beacon apparatus 30, and the like. Beacon catch information may be transmitted from beacon apparatus 30 to authentication apparatus 100 or may be transmitted from portable terminal 2 to authentication apparatus 100. In the present embodiment, it is assumed that beacon catch information is transmitted from portable terminal 2 to authentication apparatus 100.

Registration information of an incoming person is, for example, a registration number of the incoming person registered in a dedicated application in authentication system 1. Note that, registration information may be any other number, character string, or the like as long as the number, character string, or the like is information that makes it possible to identify an incoming person. Further, information that makes it possible to identify an individual incoming person indirectly, such as an identification number in an application or an identification number of portable terminal 2, may also be used as registration information.

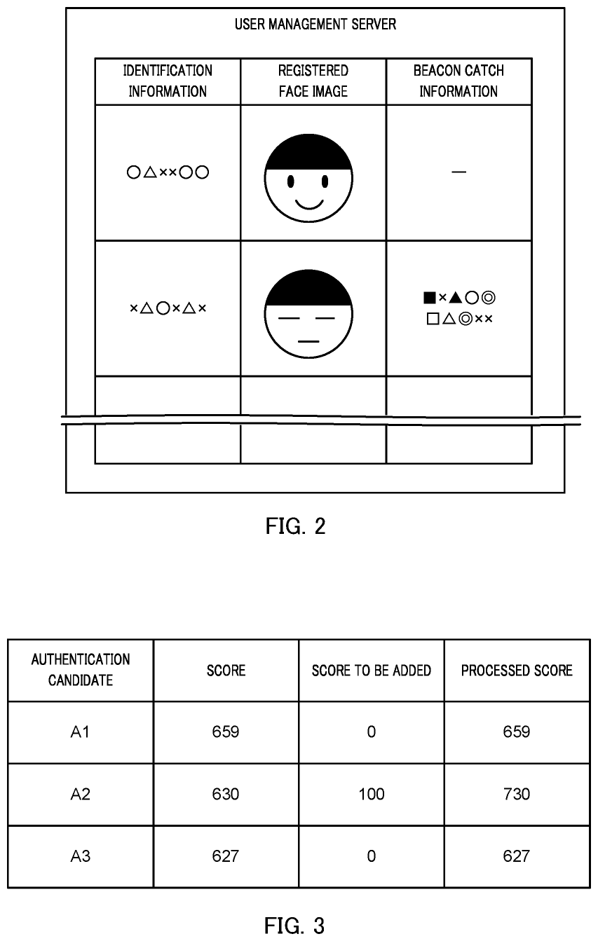

User management server 40 is a server that manages identification information of a registered person registered in authentication system 1. A face image of a registered person is registered in advance in user management server 40. A face image registered (hereinafter referred to as a “registered face image”) is associated with identification information for identifying the person in question of the registered face image and is stored in user management server 40 (for example, see FIG. 2).

This identification information is identical or can be regarded as identical to registration information that is registered by an incoming person (registered person) in the dedicated application installed into portable terminal 2, and is, for example, a number configured by combining a plurality of alphanumeric characters randomly.

Passage history management server 50 is a server that records information that indicates history of an incoming person who passes through gate apparatus 10 via authentication by authentication apparatus 100. History information that is recorded in passage history management server 50 is information on a time when an incoming person comes into gate apparatus 10, information on a time when an incoming person goes out from gate apparatus 10, and the like.

Authentication apparatus 100 is, for example, a server provided in a position different from that of gate apparatus 10, and includes a CPU (not illustrated), a ROM (not illustrated), a RAM (not illustrated), and input/output circuitry (not illustrated). Authentication apparatus 100 is configured to control authentication of an incoming person based on a preconfigured program. Authentication apparatus 100 includes receiver 110, processor 120, and authenticator 130.

Receiver 110 receives beacon catch information transmitted from portable terminal 2. Further, authentication apparatus 100 converts beacon information based on beacon catch information received by receiver 110 into position information of gate apparatus 10 which is associated with the beacon information.

Processor 120 performs processing of associating registration information of an incoming person, which is registered in portable terminal 2, with one registered face image of a plurality of registered face images. Specifically, in a case where registration information is acquired from portable terminal 2, processor 120 refers to user management server 40 and collates the registration information with identification information of registered persons associated with a plurality of registered face images in user management server 40.

In a case where a registered person who coincides with an incoming person is present, processor 120 performs processing of associating registration information with a registered face image according to identification information. Specifically, processor 120 associates identification information of a registered person with beacon catch information according to registration information that coincides with the identification information and registers the identification information associated with the beacon catch information in user management server 40.

For example, in the example of FIG. 2, in user management server 40, a table in which identification information is associated with a registered face image is provided with a column of beacon catch information. In the column of beacon catch information with respect to identification information associated with beacon catch information, for example, information included in the beacon catch information is described. In the column of beacon catch information with respect to identification information that is not associated with beacon catch information, no information is described.

Note that, beacon catch information may be associated in any form as long as it can be recognized that beacon catch information is associated with a registered face image in user management server 40. Further, beacon catch information associated with a registered face image may be registered in user management server 40 such that a transmission time and/or a reception time of the beacon catch information and/or position information of gate apparatus 10 corresponding to beacon apparatus 30 that has transmitted beacon information can be recognized. Further, beacon catch information may also include a reception time of beacon information at portable terminal 2.

Authenticator 130 authenticates, based on face image information of an incoming person who comes into gate apparatus 10, the incoming person from among a plurality of registered face images. Specifically, in a case where a face image collation request from gate apparatus 10 is acquired, authenticator 130 acquires face image information of an incoming person from image-capturing apparatus 20.

Authenticator 130 refers to user management server 40, collates the face image information with a plurality of registered face images in user management server 40, and calculates a plurality of scores according to the plurality of registered face images, respectively. The score is a value that indicates a collation result, and it is described in the present embodiment that the better a collation result (that is, an identical person is highly likely involved), the higher the score. Note that, a known method is used for calculating scores of registered face images.

Then, authenticator 130 extracts an authentication candidate(s) according to the calculated plurality of scores. More specifically, authenticator 130 excludes a registered face image(s) having a score less than an authentication threshold from authentication candidates, and causes a registered face image(s) having a score equal to or greater than the authentication threshold to be an authentication candidate(s). In the present embodiment, there is a case where score addition is performed based on beacon catch information associated with portable terminal 2 as described later. Accordingly, even when an authentication candidate has a too low score, the incoming person may be authenticated as a person authorized to enter a facility as a result of addition. In a case where a score is extremely low, however, it is also highly likely that another person may possess portable terminal 2 for certain circumstances, and thus, score addition generates erroneous authentication when even such another person is authenticated as the person in question. Accordingly, in the present embodiment, generation of such erroneous authentication is suppressed by excluding a registered face image(s) having an obviously lower score from authentication candidates in advance. Note that, the same effect is also attainable even when a registered face image(s) having a lower score is/are not excluded from authentication candidates, but is/are excluded from those that are subjected to score addition processing.

The authentication threshold is a score reference value that makes it possible to determine that face image information and a registered face image are at least similar, and can be configured as appropriate.

In a case where there is no registered face image having a score equal to or greater than the authentication threshold, authenticator 130 authenticates the incoming person as a non-registered person who is not registered in authentication system 1. In a case where there is one registered face image having a score equal to or greater than the authentication threshold, authenticator 130 authenticate an incoming person as a registered person associated with the registered face image.

In a case where there is a plurality of registered face images having a score equal to or greater than the authentication threshold, authenticator 130 confirms whether a registered face image associated with beacon catch information in which time information included in the beacon catch information is within a certain time prior to a current time is present among the plurality of registered face images.

Then, in a case where such a registered face image is present, authenticator 130 performs predetermined addition processing on the score of the registered face image. That is, in authentication processing of authenticating an incoming person, authenticator 130 prioritizes a collation result between a registered face image associated with registration information and face image information of the incoming person over a collation result between a registered face image not associated with the registration information and the face image information of the incoming person. As the time information used in this processing, any time information included in beacon catch information may be used. For example, a reception time of beacon information at portable terminal 2, a time when beacon catch information is transmitted from portable terminal 2, a time when user management server 40 receives beacon catch information are considered. It is assumed in the present embodiment that information on a reception time of beacon information at portable terminal 2 is used as an example. Further, as an example of the certain time, the certain time is configured based on, for example, a standard travel time from beacon apparatus 30 corresponding to beacon information to authentication apparatus 100. This is because a person who is currently to be subjected to authentication is unlikely to be a person corresponding to extremely old beacon information. Nonetheless, in a case where a distance between beacon apparatus 30 and authentication apparatus 100 is long or in a case where another facility is present, the certain time may be configured to be longer because a person may lose his/her way or may stop by the other facility.

Note that, in a case where position information of gate apparatus 10, which is converted by beacon information included in beacon catch information associated with a registered face image, coincides with position information of gate apparatus 10 that requires collation of a face image, the score of the registered face image is subjected to addition processing.

Authenticator 130 authenticates the incoming person as a registered person associated with a face image according to the highest score among a plurality of scores including a score having been subjected to addition processing.

For example, as illustrated in FIG. 3, it is assumed that authentication candidate A1 having a score of 659, authentication candidate A2 having a score of 630, and authentication candidate A3 having a score of 627 have been extracted. In this case, when it is assumed that the identification information of the registered face image of authentication candidate A2 is associated with beacon catch information, authenticator 130 adds, for example, 100, as a score to be added, to 630 that is the score of authentication candidate A2.

In this way, the processed score of authentication candidate A2 is 730, and thus, authentication candidate A2 has the highest score among the plurality of authentication candidates. As a result, authenticator 130 authenticates the incoming person as the registered person associated with authentication candidate A2.

In a case where authenticator 130 authenticates the incoming person as a registered person or a non-registered person, authenticator 130 transmits an authentication result to gate apparatus 10. In a case where gate apparatus 10 acquires an authentication result from authenticator 130, gate apparatus 10 controls opening/closing of the gate according to the authentication result.

Specifically, in the case of an authenticate result in which the incoming person is a non-registered person, gate apparatus 10 performs gate-closing control. Further, in the case of an authenticate result in which the incoming person is a registered person, gate apparatus performs gate-opening control.

In this way, it is possible to consider the presence or absence of beacon catch information in authentication of an incoming person, and thus, it is possible to improve authentication accuracy in authentication system 1.

Incidentally, it is assumed that beacon catch information is associated with at least two of a plurality of authentication candidates. Specifically, for example, it is assumed that a situation occurs in which when two incoming persons having similar facial features (for example, twins or the like) attempt to come into gate apparatus 10 side by side in their traveling direction, portable terminals 2 of the two incoming persons receive beacon information of beacon apparatus 30.

In this case, authenticator 130 may extract an authentication candidate in response to reception times of the beacon information. Specifically, authenticator 130 extracts, among the plurality of authentication candidates, an earlier reception time of the beacon information as an authentication candidate. This is due to determination that an incoming person having the earlier time between the two incoming persons reaches gate apparatus 10 earlier.

In this way, for example, authentication candidate extraction when a plurality of incoming persons having similar faces comes into gate apparatus 10 at equivalent timings can be easily performed. That is, even when beacon catch information is associated with at least two of a plurality of authentication candidates, considering reception times of the beacon catch information makes it easier to estimate an authentication candidate that has arrived at gate apparatus 10 earlier. For this reason, by determining that an authentication candidate that has arrived at gate apparatus 10 earlier is highly likely to pass through gate apparatus 10, it is possible to estimate the authentication candidate as the incoming person and further facilitate authentication of the incoming person.

Further, authenticator 130 may also extract an authentication candidate according to an electric field intensity of beacon information. Specifically, authenticator 130 extracts, among a plurality of authentication candidates, an authentication candidate in which the electric field intensity of beacon information according to beacon catch information is stronger. This is due to determination that, between two incoming persons, an incoming person having a stronger electric field intensity of beacon information is located closer to gate apparatus 10.

The information on an electric field intensity of beacon information may be included in beacon catch information. Further, information on an electric field intensity may be identified, for example, by being received by portable terminal 2.

In this way, for example, authentication candidate extraction when a plurality of incoming persons having similar faces comes into gate apparatus 10 at equivalent timings can be easily performed. That is, even when beacon catch information is associated with at least two of a plurality of authentication candidates, considering electric field intensities of beacon information makes it easier to estimate an authentication candidate that has arrived at gate apparatus 10 earlier. For this reason, by determining that an authentication candidate that has arrived at gate apparatus 10 earlier is highly likely to pass through gate apparatus 10, it is possible to estimate the authentication candidate as the incoming person and further facilitate authentication of the incoming person.

Further, for example, even in a case where a plurality of incoming persons (passengers) having similar faces approaches gate apparatus 10 and then one or some of the passengers does/do not come into gate apparatus 10, considering a change in the electric field intensity of beacon information makes it possible to exclude the passenger(s) who does/do not come into gate apparatus 10 from the authentication candidates. That is, considering the electric field intensity of beacon information makes it possible to improve authentication candidate extraction accuracy and further facilitate authentication of the incoming person.

Further, authenticator 130 may also determine, based on accelerometer information of portable terminal 2, an incoming person who reaches gate apparatus 10 earlier.

Accelerometer information of portable terminal 2 is, for example, information on a moving vector by an accelerometer incorporated in portable terminal 2, and may be included in beacon catch information.

In this way, even when two pieces of beacon catch information are received at substantially the same time, it is possible to estimate that an authentication candidate having a faster moving velocity arrives at gate apparatus 10 earlier and further facilitate authentication of the incoming person.

Further, authenticator 130 may extract an authentication candidate in response to the number of times of use of gate apparatus 10 and determine a registered face image whose collation result is prioritized in authentication processing. Specifically, authenticator 130 performs processing of recording and accumulating the number of times of reception of beacon catch information for each gate apparatus 10 and each time the beacon catch information is received. Note that, the number of times of reception may be recorded by the authenticator, or may be recorded by a recorder other than the authenticator. Then, in a case where beacon catch information is associated with none of a plurality of authentication candidates, authenticator 130 authenticates an incoming person with a registered face image of an authentication candidate for which the number of times of reception of beacon catch information corresponding to the same gate apparatus as a gate apparatus into which the incoming person attempts to come is the largest. Note that, the authenticator may perform the same processing by using the number of times of reception of beacon catch information corresponding to a gate apparatus installed at a location identical to the location of a gate apparatus into which the incoming person attempts to come. This is because it is difficult to consider using the same gate apparatus every time in the case of a facility such as a train station at which a plurality of gate apparatuses is installed at an identical location. Further, authenticator 130 may extract an authentication candidate according to the frequency of use of gate apparatus 10 by executing the above processing based on the number of times of reception within a certain time.

In this way, it is possible to easily perform authentication even in a case where an incoming person forgets to possess portable terminal 2 or has turned off the power supply of portable terminal 2. Note that, although it has been described above that a registered face image of an authentication candidate for which the number of times of reception of beacon catch information is the largest is extracted, it may be configured such that registered face images of a plurality of authentication candidates are extracted based on the number of times of reception or reception frequency. For example, it is conceivable to extract registered face images with the number of times of reception or frequency being equal to or greater than a predetermined threshold or to extract registered face images or the like with the number of times of reception or reception frequency being ranked in predetermined places from first place.

Further, processing of using the number of times of reception or frequency of beacon catch information may also be performed even in a case where an incoming person possesses portable terminal 2 that properly works. For example, it is conceivable to increase the score to be added when a previous number of times of reception of beacon catch information is large or as a previous reception frequency of reception of beacon catch information is higher, to add a negative score to be added in a case where a previous number of times of reception of reception of beacon catch information is small or in a case where a previous reception frequency of reception of beacon catch information is low, or the like.

Further, after an incoming person passes through gate apparatus 10, processor 120 may perform processing of erasing beacon catch information (registration information) associated with a registered face image(s) from user management server 40.

In this way, it is possible to suppress continued association of beacon catch information with a registered face image(s) after completion of authentication of an incoming person.

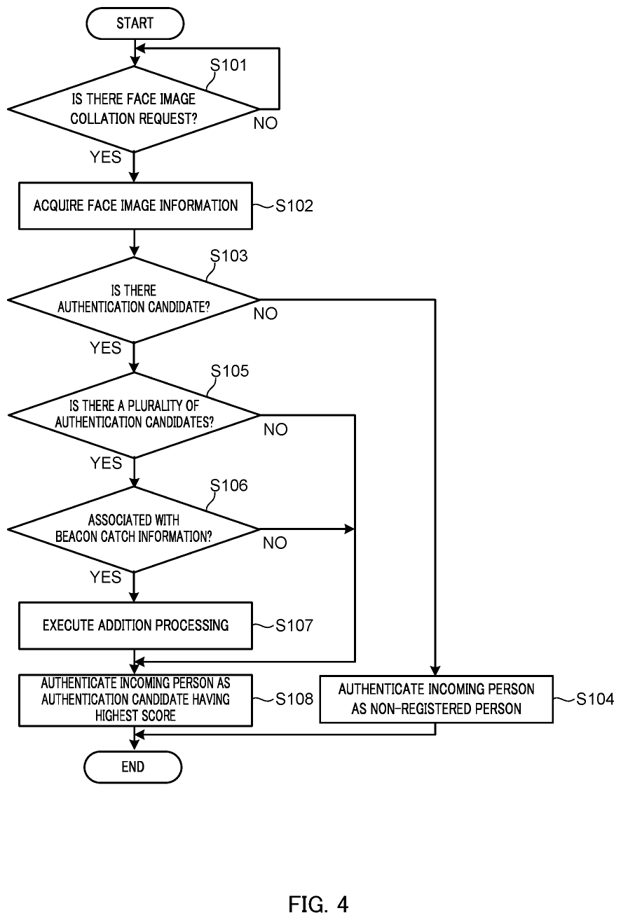

An operation example of authentication control in authentication system 1 configured as described above will be described. First, an operation example of authentication control in authentication apparatus 100 will be described. FIG. 4 is a flowchart illustrating an operation example of authentication control in authentication apparatus 100. The processing in FIG. 4 is executed as appropriate, for example, during operation of gate apparatus 10.

As illustrated in FIG. 4, authentication apparatus 100 determines whether there is a face image collation request (step S101). In a case where there is no face image collation request as a result of the determination (step S101, NO), the processing in step S101 is repeated. In a case where there is a face image collation request (step S101, YES), on the other hand, authentication apparatus 100 acquires face image information (step S102).

Authentication apparatus 100 then collates the acquired face image information with registered face images and determines whether there is an authentication candidate (step S103). In a case where there is no authentication candidate as a result of the determination (step S103, NO), authentication apparatus 100 authenticates the incoming person as a non-registered person (step S104). In a case where there is an authentication candidate (step S103, YES), on the other hand, authentication apparatus 100 determines whether there is a plurality of authentication candidates (step S105).

In a case where there is one authentication candidate as a result of the determination (step S105, NO), the processing transitions to step S108. In a case where there is a plurality of authentication candidates (step S105, YES), on the other hand, authentication apparatus 100 determines whether there is an authentication candidate associated with beacon catch information among the plurality of authentication candidates (step S106).

In a case where there is no authentication candidate associated with beacon catch information as a result of the determination (step S106, NO), the processing transitions to step S108. In a case where there is an authentication candidate associated with beacon catch information (step S106, YES), on the other hand, authentication apparatus 100 executes addition processing on the score of the authentication candidate (step S107).

Authentication apparatus 100 then authenticates the incoming person as an authentication candidate having the highest score (step S108). After step S104 or step S108, this control ends.

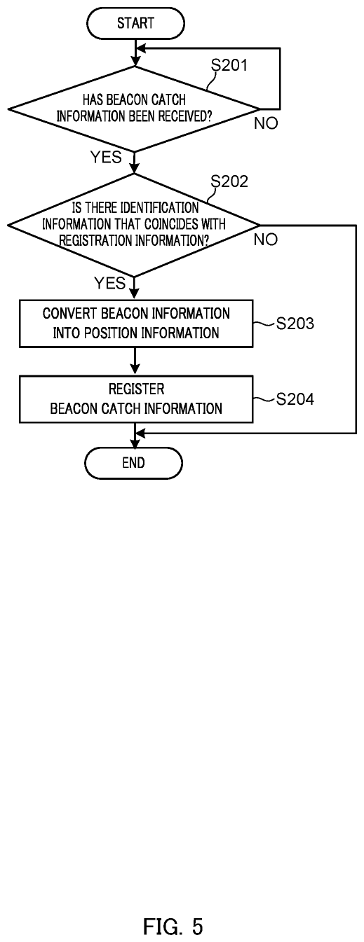

Next, an operation example of registration control of beacon catch information in authentication apparatus 100 will be described. FIG. 5 is a flowchart illustrating an operation example of registration control of beacon catch information in authentication apparatus 100. The processing in FIG. 5 is executed as appropriate, for example, during operation of gate apparatus 10.

As illustrated in FIG. 5, authentication apparatus 100 determines whether beacon catch information has been received (step S201). In a case where beacon catch information has not been received as a result of the determination (step S201, NO), the processing in step S201 is repeated. In a case where beacon catch information has been received (step S201, YES), on the other hand, authentication apparatus 100 determines whether there is identification information that coincides with registration information based on the beacon catch information (step S202).

In a case where there is no identification information that coincides with the registration information as a result of the determination (step S202, NO), this control ends. In a case where there is identification information that coincides with the registration information (step S202, YES), on the other hand, authentication apparatus 100 converts beacon information based on the beacon catch information into position information of gate apparatus 10 (step S203) and registers the beacon catch information in association with the registered face image (step S204). After step S204, this control ends.

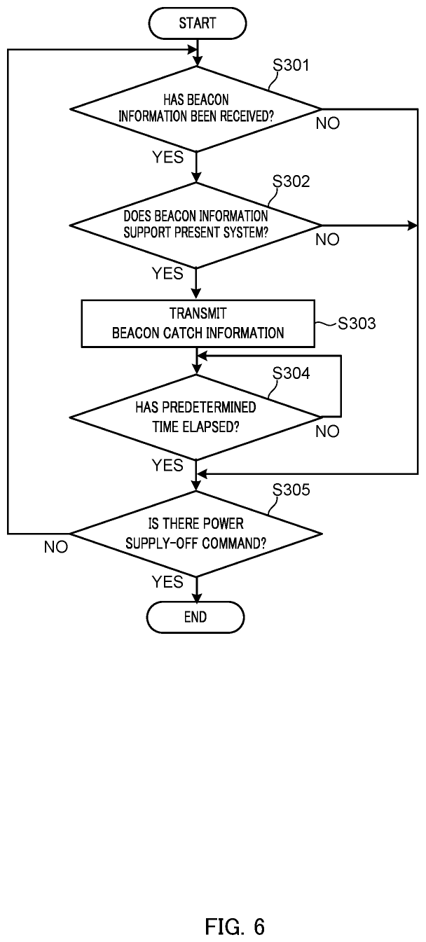

Finally, transmission control of beacon catch information in portable terminal 2 will be described. FIG. 6 is a flowchart illustrating an operation example of transmission control of beacon catch information in portable terminal 2. The processing in FIG. 6 is executed as appropriate, for example, while the power supply of portable terminal 2 is on.

As illustrated in FIG. 6, portable terminal 2 determines whether beacon information has been received (step S301). In a case where beacon information has not been received as a result of the determination (step S301, NO), the processing transitions to step S305. In a case where beacon information has been received (step S301, YES), on the other hand, portable terminal 2 determines whether the beacon information supports the system of the present embodiment (the present system) (step S302).

In a case where the beacon information does not support the system of the present embodiment as a result of the determination (step S302, NO), the processing transitions to step S305. This is because a beacon for a system different from the system of the present embodiment in a facility may also be present, and thus, such a beacon is ignored. In a case where the beacon information supports the system of the present embodiment (step S302, YES), on the other hand, portable terminal 2 transmits beacon catch information (step S303).

Next, portable terminal 2 determines whether a predetermined time has elapsed (step S304). In a case where the predetermined time has not elapsed as a result of the determination (step S304, NO), the processing in step S304 is repeated. In a case where the predetermined time has elapsed (step S304, YES), on the other hand, portable terminal 2 determines whether there is a power supply-off command (step S305).

Note that, the predetermined time is a time that is configured as appropriate in view of a transmission timing of beacon catch information. Configuring this predetermined time makes it possible to suppress frequent transmission of beacon catch information and further reduce power consumption of portable terminal 2.

In a case where there is no power supply-off command as a result of the determination (step S305, NO), the processing returns to step S301. In a case where there is a power supply-off command (step S305, YES), on the other hand, this control ends.

According to the present embodiment configured as described above, it is possible to consider the presence or absence of acquisition of beacon catch information when an incoming person is authenticated. For example, in a case where a plurality of registered face images having very similar facial features is present and when an incoming person according to one registered face image of the plurality of registered face images comes into gate apparatus 10, portable terminal 2 of the incoming person receives beacon information transmitted from beacon apparatus 30, and thus, authentication apparatus 100 acquires beacon catch information transmitted from portable terminal 2 described above.

Thus, the registration information of the incoming person in the beacon catch information and the identification information in the registered face image are collated and the identification information in the registered face image and the registration information are associated. As a result, it is possible to easily authenticate the incoming person as the registered person of the registered face image associated with the beacon catch information and further enhance authentication accuracy in authentication system 1.

Further, use of a smartphone or the like as portable terminal 2 of an incoming person enables the incoming person to pass through gate apparatus 10 without possessing any special apparatus that supports authentication system 1. That is, in the present embodiment, it is possible to enhance authentication accuracy while enjoying an advantage of gate apparatus 10 that supports face authentication.

Incidentally, it is assumed that in the case of a configuration in which beacon catch information is not used, a first incoming person between two incoming persons having similar facial features has come into gate apparatus 10. In this case, a record of the first incoming person coming into gate apparatus 10 is recorded in passage history management server 50. Then, in a case where the second incoming person between the two incoming persons having similar facial features is erroneously authenticated as the first incoming person when the second incoming person attempts to come into gate apparatus 10 before the first incoming person goes out from gate apparatus 10, a problem may occur that the second incoming person cannot come into gate apparatus 10.

In the present embodiment, on the other hand, it is possible to accurately authenticate the first incoming person and the second incoming person by considering beacon catch information, and thus, it is possible to suppress occurrence of the above-described problem. For example, when the second incoming person who possesses portable terminal 2 attempts to come into gate apparatus 10, the authentication score of the correct registered face image is added in view of beacon catch information, and thus, it is possible to reduce the possibility that the second incoming person will be erroneously authenticated as the same person as the first incoming person.

Further, in a case where the first incoming person and the second incoming person have similar facial features, the first incoming person may be erroneously authenticated as the second incoming person, but use of the beacon catch information of the first incoming person makes it possible to reduce the possibility that the first incoming person will be erroneously authenticated as the second incoming person. Thus, it can be configured such that the problem that the second incoming person cannot come into gate apparatus 10 as a result of the first incoming person being erroneously authenticated as the second incoming person hardly occurs.

Note that, in the embodiment described above, the score addition processing is performed depending on whether beacon catch information is associated with a registered face image, but the present disclosure is not limited thereto. For example, an incoming person may be authenticated based on information on a history of passage through gate apparatus 10.

For example, it is assumed that a situation occurs in which a plurality of authentication candidates is present and beacon catch information is associated with registered face images in the plurality of authentication candidates within a certain time, and in which an incoming person(s) attempt(s) to come into gate apparatus 10.

In this case, for example, authenticator 130 refers to passage history management server 50, excludes an authentication candidate(s) having already passed through gate apparatus 10, and performs processing according to authentication on an authentication candidate(s) having not passed through gate apparatus 10. Note that, in a case where all of a plurality of authentication candidates have passed through gate apparatus 10, the case may be treated as multiple comings-into or authentication processing as usual may be performed.

Further, it is assumed that a situation occurs in which a plurality of authentication candidates is present and beacon catch information is associated with registered face images in the plurality of authentication candidates within a certain time, and in which an incoming person(s) attempt(s) to go out from gate apparatus 10.

In this case, authenticator 130 refers to passage history management server 50, excludes an authentication candidate(s) having no history of coming into gate apparatus 10, and performs processing according to authentication on an authentication candidate(s) having a history of coming into gate apparatus 10. Note that, in a case where all of a plurality of authentication candidates have no history of coming into gate apparatus 10, the case may be treated as going-out rejection or authentication processing as usual may be performed.

According to such a configuration, it is possible to simplify authentication processing by using information on a passage history/histories of an incoming person(s). Further, for example, in a case where a plurality of incoming persons having slightly different scores is present on a side of coming into gate apparatus 10 and on a side of going out from gate apparatus 10, respectively, determination using passage histories of incoming persons makes it possible to easily perform identification based on the difference between the coming-into and the going-out. As a result, it is possible to enhance authentication accuracy in authentication system 1.

Further, in the embodiment described above, a processing result of processor 120 is always used in a case where a plurality of authentication candidates is present, but the present disclosure is not limited thereto. For example, it may also be configured such that authenticator 130 determines, based on score differences among a plurality of authentication candidates, whether a processing result of processor 120 is used.

Specifically, in a case where there is a plurality of registered face images having a score equal to or greater than the authentication threshold, authenticator 130 extracts, as authentication candidates, a predetermined number of registered face images in descending order of score among the plurality of scores.

The predetermined number is a number that can be configured as appropriate, such as three, for example. In the present embodiment, the predetermined number is configured as three.

Authenticator 130 determines, based on score differences among the extracted plurality of authentication candidates, whether a processing result of processor 120 is used. In a case where, among the plurality of authentication candidates, an authentication candidate is present for which a score difference between the authentication candidate and an authentication candidate having the highest score is equal to or greater than a threshold, authenticator 130 determines that a processing result of processor 120 is not used. That is, in a case where the score difference is equal to or greater than the threshold, authenticator 130 performs authentication processing without prioritizing a collation result between a registered face image associated with registration information and face image information of an incoming person.

In this case, authenticator 130 authenticates the incoming person as a registered person associated with a registered face image of an authentication candidate having the highest score among the plurality of authentication candidates, for example. The threshold is such a small value that becomes a slight difference as a score difference, and is configured as appropriate.

In a case where a score difference between an authentication candidate and an authentication candidate having the highest score among a plurality of authentication candidates is less than the threshold, authenticator 130 determines that a processing result of processor 120 is used. In a case where, among the plurality of authentication candidates, a registered face image associated with registration information of an incoming person by processor 120 is present, authenticator 130 performs predetermined addition processing on a score of an authentication candidate according to the registered face image.

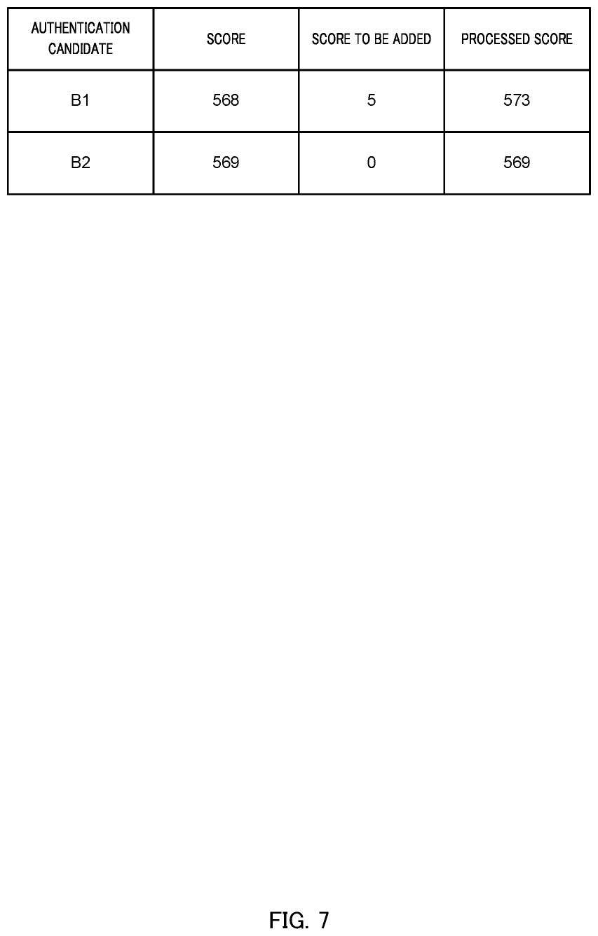

For example, as illustrated in FIG. 7, it is assumed that authentication candidate B1 having a score of 568 and authentication candidate B2 having a score of 569 have been extracted. In this case, when it is assumed that identification information of the registered face image of authentication candidate B1 is associated with beacon catch information, authenticator 130 adds, for example, five to 568 that is the score of authentication candidate B1.

In this way, the score of authentication candidate B1 is 573, and thus, authentication candidate B1 has the highest score among the plurality of authentication candidates. As a result, authenticator 130 authenticates the incoming person as a registered person associated with authentication candidate B1.

Further, in a case where beacon catch information is associated with at least two authentication candidates among a plurality of authentication candidates having slight score differences, authenticator 130 may authenticate the incoming person according to registration dates of registered face images.

The older a registration date of a registered face image, the more likely facial features of the registered person may have changed, and thus, it is possible to easily extract an authentication candidate by extracting, as the authentication candidate, an authentication candidate having a more recent registration date.

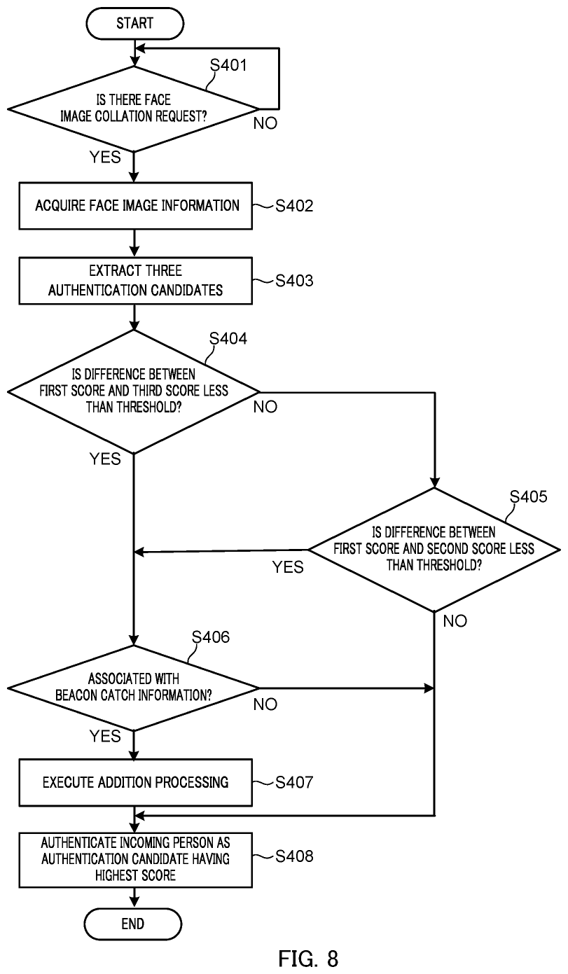

An operation example of authentication control in authentication system 1 configured as described above will be described. First, an operation example of authentication control in authentication apparatus 100 will be described. FIG. 8 is a flowchart illustrating an operation example of authentication control in authentication apparatus 100. The processing in FIG. 8 is executed as appropriate, for example, during operation of gate apparatus 10.

As illustrated in FIG. 8, authentication apparatus 100 determines whether there is a face image collation request (step S401). In a case where there is no face image collation request as a result of the determination (step S401, NO), the processing in step S401 is repeated. In a case where there is a face image collation request (step S401, YES), on the other hand, authentication apparatus 100 acquires face image information (step S402).

Authentication apparatus 100 then extracts three authentication candidates (step S403). Note that, this flowchart assumes that there are authentication candidates having a score equal to or greater than the authentication threshold.

When authentication apparatus 100 has extracted three authentication candidates, authentication apparatus 100 determines whether a difference between a first score of an authentication candidate, where the first score is the largest among the three scores, and a third score of an authentication candidate, where the third score is the third among the three scores, is less than the threshold (step S404). In a case where the difference between the first score and the third score is less than the threshold as a result of the determination (step S404, YES), the processing transitions to step S406.

In a case where the difference between the first score and the third score is less than the threshold is equal to or greater than the threshold (step S404, NO), on the other hand, authentication apparatus 100 determines whether a difference between the first score and a second score of the authentication candidate, where the second score is the second among the three scores, is less than the threshold (step S405). In a case where the difference between the first score and the second score is equal to or greater than the threshold as a result of the determination (step S405, NO), the processing transitions to step S408.

In a case where the difference between the first score and the second score is less than the threshold (step S405, YES), on the other hand, authentication apparatus 100 determines whether there is an authentication candidate associated with beacon catch information among the three authentication candidates (step S406).

In a case where there is no authentication candidate associated with beacon catch information as a result of the determination (step S406, NO), the processing transitions to step S408. In a case where there is an authentication candidate associated with beacon catch information (step S406, YES), on the other hand, authentication apparatus 100 executes addition processing on the score of the authentication candidate (step S407).

Authentication apparatus 100 then authenticates the incoming person as the authentication candidate having the highest score (step S408). This control then ends.

According to such a configuration, the presence or absence of association with beacon catch information is considered only in a case where a score difference becomes a slight difference, and thus, it is possible to omit wasteful processing. Further, in a case where an incoming person different from the possessor of portable terminal 2 possesses portable terminal 2 described above and attempts to pass through gate apparatus 10, the registered face image to be associated with beacon catch information is the image of the possessor of portable terminal 2 and the image of the incoming person is not associated therewith. Accordingly, when the incoming person comes into gate apparatus 10, it is possible to suppress addition processing on the score of the registered face image according to the incoming person.

Further, since an accurate registered face image can be selected from registered face images having slight score differences and an incoming person can be authenticated by performing addition processing using beacon catch information, it is possible to enhance authentication accuracy.

Further, the threshold may vary depending on a score level of an extracted authentication candidate. For example, it is conceivable to enlarge the threshold range in the case of a low score level. In the case of a low score level, the accuracy of face authentication itself highly likely decreases due to the influence of face orientation, illumination, a state of face concealment, and/or the like. For this reason, in the case of a low score level, it is highly likely that a correct authentication result will be obtained by performing determination using beacon catch information in combination rather than by performing determination depending solely on face authentication with decreased accuracy. In this respect, since determination using beacon catch information in combination is performed in the present embodiment when scores are determined to be slightly different, it is possible to perform control such that determination using beacon catch information in combination is likely to occur by enlarging the threshold range in the case of a low score level. Note that, in the case of a high score level and sufficiently reliable face authentication accuracy, it is highly likely that an accurate determination has been performed even when a score difference between authentication candidates is small. For this reason, a determination result may become erroneous when addition processing using beacon catch information is performed, and thus, it may also be configured such that the threshold range is narrowed in the case of a high score level to cause addition processing to less likely occur.

Further, although one beacon apparatus 30 is provided corresponding to one gate apparatus 10 in the embodiment described above, the present disclosure is not limited thereto. For example, a plurality of beacon apparatuses 30 may be provided corresponding to one gate apparatus 10.

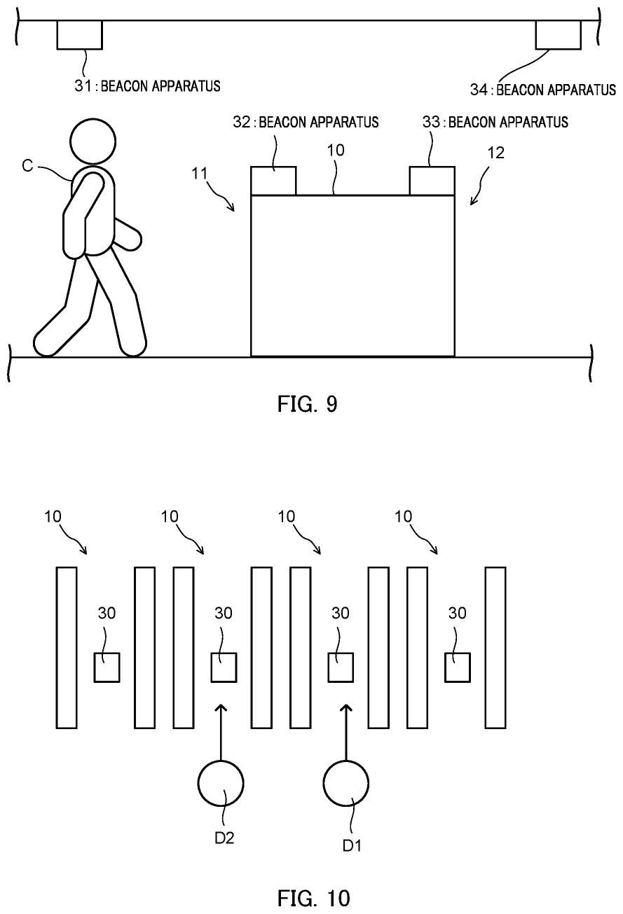

For example, gate apparatus 10 illustrated in FIG. 9 is provided with four beacon apparatuses 31, 32, 33, and 34. Note that, gate apparatus 10 in FIG. 9 includes entrance 11 and exit 12, and it is assumed that the direction from entrance 11 to exit 12 in FIG. 9 is the incoming direction of an incoming person who comes into gate apparatus 10.

First beacon apparatus 31 is provided on a side in front of entrance 11 of gate apparatus 10 (an upstream side in the incoming direction of an incoming person). First beacon apparatus 31 is provided on the ceiling or the like of a facility at which gate apparatus 10 is disposed.

Second beacon apparatus 32 is provided in a position corresponding to entrance 11 of gate apparatus 10. Third beacon apparatus 33 is provided in a position corresponding to exit 12 of gate apparatus 10. That is, third beacon apparatus 33 is provided in gate apparatus 10 on a downstream side of second beacon apparatus 32 in the incoming direction of an incoming person.

Fourth beacon apparatus 34 is provided on a side beyond exit 12 of gate apparatus 10 (a downstream side in the incoming direction of an incoming person). Fourth beacon apparatus 34 is provided on the ceiling or the like of a facility at which gate apparatus 10 is disposed.

Such a configuration makes it easy to determine the traveling direction of a passenger passing near gate apparatus 10, and therefore makes it easy to grasp whether a passenger corresponds to an incoming person.

For example, authenticator 130 easily determines the traveling direction of a passenger based on reception times of beacon catch information based on beacon information transmitted from each of beacon apparatuses 31, 32, 33, and 34.

Specifically, when portable terminal 2 of a passenger receives beacon information transmitted from each of beacon apparatuses 31, 32, 33, and 34 and authentication apparatus 100 acquires beacon catch information, authentication apparatus 100 records first, second, third, and fourth reception times of the beacon catch information.

The first reception time is a reception time of beacon catch information based on first beacon apparatus 31. The second reception time is a reception time of beacon catch information based on second beacon apparatus 32. The third reception time is a reception time of beacon catch information based on third beacon apparatus 33. The fourth reception time is a reception time of beacon catch information based on fourth beacon apparatus 34.

In a case where a passenger comes into gate apparatus 10, authentication apparatus 100 acquires beacon catch information at reception times in the order of, for example, the first reception time, the second reception time, the third reception time, and the fourth reception time, and thus, it is possible to estimate that the passenger is an incoming person.

Further, in a case where a passenger approaches gate apparatus 10 but returns without coming into gate apparatus 10, authentication apparatus 100 acquires beacon catch information only at the first and second reception times, and thus, it is possible to estimate that the passenger is not an incoming person.

That is, in a case where beacon catch information is associated with registered face images of at least two authentication candidates among a plurality of authentication candidates, this configuration makes it easy to exclude an authentication candidate according to a registered face image which is not estimated as an incoming person. As a result, authentication accuracy for an incoming person can be enhanced.

Further, in this configuration, authentication apparatus 100 may record a plurality of reception times among the first through fourth reception times depending on the ranges of transmission of beacon information by the beacon apparatuses even when a passenger does not pass through gate apparatus 10.

For this reason, authentication apparatus 100 may estimate an incoming person in view of electric field intensities of beacon information transmitted from each of beacon apparatuses 31, 32, 33, and 34.

For example, it is assumed that passenger C has traveled near first beacon apparatus 31 in gate apparatus 10. In this case, authentication apparatus 100 records the beacon catch information according to first beacon apparatus 31 and the beacon catch information according to second beacon apparatus 32.

Since first beacon apparatus 31 is located closer to passenger C than second beacon apparatus 32, the electric field intensity of the beacon information of first beacon apparatus 31 is larger than the electric field intensity of the beacon information of second beacon apparatus 32. For this reason, it is possible to estimate that passenger C is located in a position before coming into gate apparatus 10.

Further, when passenger C approaches entrance 11 of gate apparatus 10, passenger C moves away from first beacon apparatus 31, but approaches second beacon apparatus 32. For this reason, the electric field intensity of the beacon information of second beacon apparatus 32 is larger than the electric field intensity of the beacon information of first beacon apparatus 31. For this reason, it is possible to estimate that passenger C is located in a position closer to gate apparatus 10 and is approaching gate apparatus 10.

Further, when passenger C is in gate apparatus 10, authentication apparatus 100 records at least the beacon catch information according to second beacon apparatus 32 and the beacon catch information according to third beacon apparatus 33.

In a case where passenger C is located in gate apparatus 10, passenger C is located near an intermediate point between second beacon apparatus 32 and third beacon apparatus 33, and thus, the electric field intensities of the respective pieces of beacon information have approximate values. For this reason, it is possible to estimate that passenger C is located in gate apparatus 10 and further passenger C can be easily extracted as an authentication candidate.

Further, in a case where passenger C approaches gate apparatus 10 but returns, authentication apparatus 100 does not record the beacon catch information according to third beacon apparatus 33 or the electric field intensity of the beacon information is small. For this reason, it is possible to estimate that passenger C has no intention of coming into gate apparatus 10 and further passenger C can be easily excluded from authentication candidates.

Further, when passenger C passes through gate apparatus 10, passenger C moves away from third beacon apparatus 33, but approaches fourth beacon apparatus 34. For this reason, the electric field intensity of the beacon information of fourth beacon apparatus 34 is larger than the electric field intensity of the beacon information of third beacon apparatus 33. For this reason, it is possible to estimate that passenger C has passed through gate apparatus 10.

Since the position of passenger C (incoming person) can be accurately estimated thereby, it is possible to accurately manage entry and exit records of the incoming person.

Further, by accurately estimating the position of passenger C, an authentication result of authentication apparatus 100 may be determined, for example, given the fact that passenger C has passed through gate apparatus 10.

For example, it is assumed that a plurality of passengers having similar faces approaches apparatus 10 at equivalent timings, and one passenger (incoming person) has passed through gate apparatus 10, whereas the remaining passenger(s) has/have not passed through gate apparatus 10.

In this case, authentication apparatus 100 may not be able to extract an authentication candidate accurately since beacon catch information in all of the plurality of passengers is associated with each registered face image.

For this reason, it is configured such that at the time when the incoming person has not passed through gate apparatus 10, an authentication result of authentication apparatus 100 is not determined and authentication apparatus 100 acquires beacon catch information again.

In this way, it is possible to confirm that the position of a passenger who does not pass through gate apparatus 10 stops in a position in front of gate apparatus 10, and that the incoming person advances to a position beyond gate apparatus 10. As a result, an authentication result of authentication apparatus 100 can be accurate.

Further, in a case where a plurality of beacon apparatuses is provided, the application in portable terminal 2 may cause beacon information received within a predetermined time to be collectively transmitted as beacon catch information. The predetermined time can be arbitrarily configured based on an amount of information that can be transmitted, an operating time of a facility, and/or the like. For example, in the case of a typical facility whose daily operating time is defined, the predetermined time may be one day because it is unlikely that a situation in which face authentication should be performed across days will occur. Further, the predetermined time may be a time adjustable by an arrangement relationship of beacon apparatuses, a moving velocity/velocities of a passenger(s), and//or the like.

Further, in a case where portable terminal 2 transmits beacon catch information and then the electric field intensity of the beacon information changes more than a specified value, portable terminal 2 may transmit the beacon catch information again.

Further, in the configuration illustrated in FIG. 9, a plurality of beacon apparatuses is provided side by side in the traveling direction of an incoming person. In a case where a plurality of gate apparatuses is arranged side by side, however, a plurality of beacon apparatuses may be provided side by side in the direction in which the plurality of gate apparatuses is arranged.

For example, in a case where a plurality of gate apparatuses 10 is provided side by side in a direction perpendicular to the traveling direction of an incoming person as illustrated in FIG. 10, beacon apparatuses 30 are provided corresponding to gate apparatuses 10, respectively. Beacon apparatuses 30 are provided, for example, on a ceiling part of a facility at which gate apparatuses 10 are arranged.

In this case, it is possible to estimate which gate apparatus 10 an incoming person attempts to come into based on differences among electric field intensities of beacon information transmitted from beacon apparatuses 30.

For example, in a case where incoming person D1 comes into gate apparatus 10 that is the second from the right in FIG. 10, the electric field intensity according to the beacon information of beacon apparatus 30 that is the second from the right in FIG. 10 becomes the largest among the electric field intensities according to the beacon information. For this reason, it is possible to estimate that incoming person D1 passes through gate apparatus 10 that is the second from the right in FIG. 10.

Further, in a case where incoming person D2 comes into gate apparatus 10 that is the second from the left in FIG. 10, the electric field intensity according to the beacon information of beacon apparatus 30 that is the second from the left in FIG. 10 becomes the largest among the electric field intensities according to the beacon information. For this reason, it is possible to estimate that incoming person D1 passes through gate apparatus 10 that is the second from the left in FIG. 10.

In this way, it is possible to easily identify an incoming person by estimating the gate apparatus which the incoming person passes through.

Further, in the embodiment described above, authentication apparatus 100 acquires beacon catch information based on beacon information, but the present disclosure is not limited thereto. The authentication apparatus may acquire information other than beacon catch information as long as the information includes registration information of an incoming person.

Further, in the embodiment described above, in a case where a registered face image associated with beacon catch information is present among a plurality of authentication candidates, predetermined addition processing is performed on the score of the authentication candidate according to the registered face image, but the present disclosure is not limited thereto. For example, in a case where a registered face image associated with beacon catch information is present among a plurality of authentication candidates, the incoming person may be authenticated as the registered person according to the registered face image.

Further, in the embodiment described above, authenticator 130 excludes a registered face image having a score less than the authentication threshold from authentication candidates, causes a registered face image having a score equal to or greater than the authentication threshold as an authentication candidate, and then determines whether score addition processing using beacon catch information is performed on the authentication candidate. The processing of excluding a registered face image having a score less than the authentication threshold from authentication candidates, however, may be omitted. That is, all authentication candidates may be regarded as authentication candidates and it may be determined whether all authentication candidates are to be subjected to the score addition processing.

Further, in the embodiment described above, gate apparatus 10 having an opening/closing function has been described as an example, but the present invention is not limited thereto. The configuration of the embodiment described above may be applied to a gate apparatus having no opening/closing function. As an example of the gate apparatus having no opening/closing function, a pole-shaped gate apparatus that monitors and records a passenger is considered.

Further, the embodiment described above has a configuration in which the receiver, the processor, and the authenticator are included in the authentication apparatus, but the present disclosure is not limited thereto, and the receiver, the processor, and the authenticator may be provided separately. In particular, as face authentication methods, numerous methods including those in which a series of processing are completed by a single apparatus and those in which a number of apparatuses perform processing in cooperation are known, but the method in the embodiment described above is applicable regardless of the process or configuration for score calculation as long as it is a method in which face authentication is performed based on scores.

Further, in the embodiment described above, addition processing is performed on the score of a registered face image corresponding to beacon catch information, but any other method may also be used. The method is not limited to score addition when a collation result between face image information of a user attempting to come into gate apparatus 10 and a registered face image corresponding to beacon catch information is prioritized over a collation result between the face image information of the user and another registered face image (that is, authentication as a person authorized to pass through gate apparatus 10 is easily performed). For example, it is conceivable to lower the authentication threshold only in evaluation of a collation result with a registered face image corresponding to beacon catch information, or the like.

Further, in the embodiment described above, the user management server and the passage history management server are provided separately from the authentication apparatus, but the present disclosure is not limited thereto, and the user management server and the passage history management server may be included in the authentication apparatus.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

The disclosure of Japanese Patent Application No. 2021-087546, filed on May 25, 2021, including the specification, drawings and abstract is incorporated herein by reference in its entirety.

### INDUSTRIAL APPLICABILITY

The authentication apparatus of the present disclosure is useful as an authentication apparatus and an authentication system each capable of enhancing authentication accuracy while enjoying an advantage of a gate apparatus that supports face authentication.

### REFERENCE SIGNS LIST

1 Authentication system
2 Portable terminal
10 Gate apparatus
20 Image-capturing apparatus
30 Beacon apparatus
40 User management server
50 Passage history management server
100 Authentication apparatus
110 Receiver
120 Processor
130 Authenticator

1. An authentication apparatus, comprising:
a processor that performs processing of associating, in a case where a portable terminal of an incoming person who comes into a gate apparatus is present near the gate apparatus, registration information with one registered face image of a plurality of registered face images, the registration information being information of the incoming person who comes into the gate apparatus and being registered in the portable terminal; and
an authenticator that prioritizes, in authentication processing of authenticating the incoming person based on collation results between face image information of the incoming person and the plurality of registered face images, a collation result between the registered face image associated with the registration information and the face image information of the incoming person over a collation result between a registered face image not associated with the registration information and the face image information of the incoming person.

2. The authentication apparatus according to claim 1, wherein the authenticator authenticates the incoming person as a person corresponding to the registered face image in a case where a score is higher than a predetermined authentication threshold, the score being a value that indicates the collation result between the face image information of the incoming person and the registered face image.

3. The authentication apparatus according to claim 2, wherein the authenticator prioritizes the collation result between the registered face image associated with the registration information and the face image information of the incoming person by performing predetermined addition processing on a score indicating the collation result between the registered face image associated with the registration information and the face image information of the incoming person.

4. The authentication apparatus according to claim 2, wherein the authenticator prioritizes the collation result between the registered face image associated with the registration information and the face image information of the incoming person by lowering the authentication threshold with respect to a score indicating the collation result between the registered face image associated with the registration information and the face image information of the incoming person.

5. The authentication apparatus according to claim 2, wherein:
the authenticator extracts authentication candidates according to scores indicating the collation results between the face image information of the incoming person and the plurality of registered face images, and
in a case where the registered face image associated with the registration information is not included in the authentication candidates, the authenticator performs the authentication processing without prioritizing the collation result between the registered face image associated with the registration information and the face image information of the incoming person.

6. The authentication apparatus according to claim 2, wherein in a case where a score difference is equal to or greater than a predetermined threshold, the authenticator performs the authentication processing without prioritizing the collation result between the registered face image associated with the registration information and the face image information of the incoming person, the score difference being a difference between a score indicating the collation result between the registered face image associated with the registration information and the face image information of the incoming person and a score indicating the collation result between the registered face image not associated with the registration information and the face image information of the incoming person.

7. The authentication apparatus according to claim 6, wherein the authenticator configures the predetermined threshold to be larger as a level of the score is lower.

8. The authentication apparatus according to claim 1, further comprising a recorder that records a number of times or frequency of each of the plurality of registered face images being associated with the registration information, wherein
the authenticator determines, in the authentication processing, the registered face image in the collation result between the registered face image associated with the registration information and the face image information of the incoming person, according to the number of times or frequency, the collation result being prioritized.

9. The authentication apparatus according to claim 8, wherein:
the recorder further records a location of the gate apparatus that causes the registration information to be associated with the registered face image, and
the authenticator determines, in the authentication processing, the registered face image in the collation result between the registered face image associated with the registration information and the face image information of the incoming person, according to the number of times or frequency at a location identical to the location of the gate apparatus into which the incoming person attempts to come, the collation result being prioritized.

10. The authentication apparatus according to claim 1, wherein the processor performs processing of associating the registration information and the one registered face image of the plurality of registered face images in response to reception of beacon information from a beacon apparatus by the portable terminal, the beacon apparatus being provided corresponding to the gate apparatus.

11. The authentication apparatus according to claim 1, wherein:
the registration information is a registration number of the incoming person, the registration number being registered in an application of an authentication system, the application being installed into the portable terminal, and
the plurality of registered face images is face images of persons authorized to enter and exit a facility, the face images being registered in the authentication system, the facility being a facility at which the gate apparatus is disposed.

12. An authentication method, comprising:
performing processing of associating, in a case where a portable terminal of an incoming person who comes into a gate apparatus is present near the gate apparatus, registration information with one registered face image of a plurality of registered face images, the registration information being information of the incoming person who comes into the gate apparatus and being registered in the portable terminal; and
prioritizing, in authentication processing of authenticating the incoming person based on collation results between face image information of the incoming person and the plurality of registered face images, a collation result between the registered face image associated with the registration information and the face image information of the incoming person over a collation result between a registered face image not associated with the registration information and the face image information of the incoming person.

13. An authentication system, comprising:
a gate apparatus that allows an incoming person to come into the gate apparatus;
an image-capturing apparatus that is provided corresponding to the gate apparatus and captures face image information of the incoming person;
a beacon apparatus that is provided corresponding to the gate apparatus and transmits beacon information to a portable terminal possessed by the incoming person; and
an authentication apparatus that associates registration information with one registered face image of a plurality of registered face images in response to reception of the beacon information by the portable terminal, the registration information being information of the incoming person who comes into the gate apparatus and being registered in the portable terminal, the authentication apparatus prioritizing, in authentication processing of authenticating the incoming person based on collation results between the face image information and the plurality of registered face images, a collation result between the registered face image associated with the registration information and the face image information of the incoming person over a collation result between a registered face image not associated with the registration information and the face image information of the incoming person.

14. The authentication system according to claim 13, wherein in a case where there are some or all of the plurality of registered face images associated with the registration information, the authentication apparatus extracts an authentication candidate from the some or all of the plurality of registered face images associated with the registration information in response to a reception time of the beacon information at the portable terminal, the authentication candidate being subjected to the authentication processing.

15. The authentication system according to claim 13, wherein in a case where there are some or all of the plurality of registered face images associated with the registration information, the authentication apparatus extracts an authentication candidate from the some or all of the plurality of registered face images associated with the registration information in response to electric field intensities of the beacon information at the portable terminal, the authentication candidate being subjected to the authentication processing.

16. The authentication system according to claim 13, wherein a plurality of the beacon apparatuses is provided.

17. A program to be executed by a computer of a portable terminal to control the portable terminal, the portable terminal being used together with an authentication apparatus, the authentication apparatus performing actions comprising:
performing processing of associating registration information with one registered face image of a plurality of registered face images, the registration information being transmitted from the portable terminal and indicating a user of the portable terminal; and
prioritizing, in authentication processing of authenticating an incoming person who comes into a gate apparatus based on collation results between face image information of the incoming person and the plurality of registered face images, a collation result between the registered face image associated with the registration information and the face image information of the incoming person over a collation result between a registered face image not associated with the registration information and the face image information of the incoming person; and
the program causing, in a case where beacon information is received, the computer of the portable terminal to execute processing of controlling such that the beacon information and the registration information are transmitted.

18. The program according to claim 17, wherein:
the program causes the computer of the portable terminal to execute processing of storing a plurality of pieces of beacon information in a case where the plurality of pieces of beacon information are received within a predetermined time, and
the program causes the computer of the portable terminal to execute processing of controlling such that the plurality of pieces of beacon information are collectively transmitted together with the registration information when the predetermined time has elapsed.
